(19) United States
(12) Patent Application Publication
(10) Pub. No.: US 2008/0035182 A1
(43) Pub. Date: Feb. 14, 2008

(54) Substrate Treatment Apparatus

(75) Inventors: Katsuyoshi Nakatsukasa, Asakuchi-gun (JP); Hiroshi Yamaguchi, Asakuchi-gun (JP); Kazuhisa Ogasawara, Asakuchi-gun (JP); Hiroshi Kizawa, Asakuchi-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: S.E.S. Co. Ltd., Tokyo (JP)

(21) Appl. No.: 11/574,760

(22) PCT Filed: May 23, 2005
(86) PCT No.: PCT/JP05/09331

§ 371 Date: Mar. 6, 2007

(30) Foreign Application Priority Data
Sep. 22, 2004 (JP) 2004-275679

(51) Int. Cl. B08B 3/00

(52) U.S. Cl. 134/88

(57) ABSTRACT

A substrate treatment apparatus, comprising a box-shaped treatment tank (11) having an opening part at its upper side and a cover body (21) openably covering the opening part of the treatment tank. The cover body (21) is characterized in that a drying chamber (23) storing and drying a treated substrate (W) is formed therein, the treatment tank (11) is so formed that at least three of treatment fluid feed nozzle tubes (14a) to (14c) and (14a′) to (14c′) are disposed at each of the opposed side wall faces thereof forming the box shape horizontally at specified intervals and these feed nozzle tubes (14a) to (14c) and (14a′) to (14c′) are formed to be connected to a switching mechanism to supply a treatment fluid from the opposed side wall sides while alternately switching them at the opposed side wall faces. Thus, the treatment of various types of chemical liquids, flushing, and drying can be performed in the same treatment tank.

### FIELD OF THE INVENTION

The present invention relates to a substrate treatment apparatus for cleaning and drying various types of substrates, such as a semiconductor wafer and a glass substrate for a liquid crystal. More specifically, the present invention relates to a substrate treatment apparatus in which the treatment of various types of chemical liquids, flushing, and drying can be performed in the same treatment bath.

### RELATED ART

Various types of substrate treatment apparatus have been used for removing contamination on the surface of a semiconductor wafer (hereinafter, referred to as “wafer”), such as particles, organic contaminants and metal impurities. Among them, a so-called wet substrate treatment apparatus in which a wafer is treated while being immersed in a treatment liquid is widely used, because with the wet substrate treatment apparatus, not only the above-noted contamination can be effectively removed, but also a batch treatment can be performed, so that the throughput thereof is satisfactory.

The treatment with this substrate treatment apparatus includes a chemical liquid treatment using ammonia, sulfuric add, fluoric acid or the like, flushing using pure water or the like and drying using isopropyl alcohol (IPA) or the like to the wafer. This substrate treatment apparatus employs a batch treatment system in which for example, in each of a plurality of treatment baths and a drying chamber which are lined up according to the order of treatments, various types of chemical liquids (e.g., ammonia, sulfuric acid, hydrochloric acid, fluoric acid), pure water and IPA are respectively charged and a plurality of wafers are immersed sequentially in the treatment baths and dried (for example, see Patent Documents 1 and 2 below).

FIG. 12 is a plan view showing a substrate treatment apparatus employing a batch treatment system described in Patent Document 1. FIG. 13 is a schematic cross-sectional view of one cleaning device in the substrate treatment apparatus shown in FIG. 12.

The substrate treatment apparatus 100 is provided with a cleaning treatment part 101 which includes sequentially from the side of a loader part 102, a chuck cleaning and drying treatment bath 104 for cleaning and drying a wafer chuck of a wafer conveying device 103, a chemical liquid cleaning treatment bath 105 for treating impurities, such as organic contaminants, metal impurities and particles, on the surface of the wafer, a flushing cleaning treatment bath 106 for cleaning the wafer treated in the chemical liquid cleaning treatment bath 105 with pure water, a chemical liquid cleaning treatment bath 107 for removing metal contaminants on the surface of the wafer by another chemical liquid, a flushing cleaning treatment bath 108 for cleaning the wafer cleaned in the chemical liquid cleaning treatment bath 107 with pure water, a cleaning device 109 for not only cleaning the wafer by removing an oxide film on the surface of the wafer by a chemical liquid, but also rinsing the cleaned wafer, flushing and drying the wafer, and a chuck cleaning and drying bath 110 for cleaning and drying the wafer chuck of the wafer conveying device 103. The wafer is stored in each of the treatment baths 104 to 107 sequentially to be cleaned with chemical liquids and pure water and then, is subjected to drying in the treatment device 109 and the drying bath 110.

The cleaning device 109 includes, as shown in FIG. 13, a cleaning bath 111 in which the wafer is immersed in a chemical liquid and a rinsing liquid which are pooled in the cleaning bath 111, and a cylinder-shaped drying chamber 112 which is arranged over the cleaning bath 111 and in which the wafer conveyed from the cleaning bath 111 is dried. Further, the cleaning bath 111 and the drying chamber 112 are connected to each other, i.e., are produced integrally.

In the upper part and the lower part of the drying chamber 112, opening parts 113 and 114, respectively, for the hand-over of the wafer are provided. The upper opening part 113 has a sealing cover 115, and the lower opening part 114 has a rotating door mechanism 116 or a sliding door mechanism (not shown in FIG. 13), so that the wafer is dried in the drying chamber.

Further, a substrate treatment apparatus in which treatments with various types of treatment liquids can be performed in a single bath has been already introduced (For example, see Patent Document 2). FIG. 14 is a schematic view showing a treatment bath used in the substrate treatment apparatus described in Patent Document 2.

The substrate treatment apparatus 120 includes a substrate treatment part 121 equipped with a treatment bath 122 for providing the wafer with a surface treatment by immersing the wafer in a mixed treatment liquid, a mixed treatment liquid supply part 123 for mixing a chemical liquid with pure water and supplying the resultant mixed treatment liquid to the treatment bath 122, and a setting device (not shown in FIG. 14) for setting a mixing condition determining a desired value of the concentration of the mixed treatment liquid.

The mixed treatment liquid supply part 123 includes a mixing part 124 for mixing each of the chemical liquids with pure water, a supply line 125 for supplying the mixed treatment liquid mixed in the mixing part 124 to the treatment bath 122, a pure water supply line 126 for supplying pure water to the mixing part 124, one or more chemical liquid supply line(s) 127 for supplying individually each of chemical liquids to the mixing part 124, a chemical liquid supply controlling 128 for controlling the supplying amounts of pure water and each chemical liquid to the mixing part 124 according to a furnished signal for manipulating a pure water supplying amount, a concentration monitor 129 for monitoring a present concentration value of the mixed treatment liquid, and a controlling part (not shown in FIG. 14) for furnishing a chemical liquid signal which dissolves a concentration deviation between the desired concentration value and present concentration value of the mixed treatment liquid to the chemical liquid supply controlling mechanism 128. The controlling part has a function of controlling the chemical liquid supply controlling mechanism 128 by a feedback control based on the present concentration value of the mixed treatment liquid which is monitored by the concentration monitor 129 in order to supply the mixed treatment liquid having a desired concentration value to the treatment bath 122.

### [Patent Document 1]

JP-10-209109-A (FIG. 2, FIG. 3 and paragraphs [0030] to [0035])

### [Patent Document 2]

JP-2000-21838-A (FIG. 1 and paragraphs [0029] to [0031])

### DISCLOSURE OF THE INVENTION

### Problem to be solved

A substrate treatment apparatus is introduced in Patent Documents 1 and 2 and other various types of the substrate treatment apparatus are known. However, in these types of the substrate treatment apparatus, it is extremely difficult to perform a series of treatments including the treatment of various types of chemical liquids, flushing and drying in the same treatment bath and such a substrate treatment apparatus that can perform the above-noted series of treatments in the same treatment bath has not yet been put to practical use.

Examples of various reasons therefor are as follows. When a series of treatments including the treatment of various types of chemical liquids, flushing and drying are performed in the same treatment bath, an exchanging speed, i.e. a replacing speed of various types of treatment liquids in a single bath is limited. For example, after the completion of a treatment with a treatment liquid A, when the treatment liquid A in the treatment bath is replaced with a treatment liquid B, the treatment liquid A remains in the bath and the treatment liquids A and B are mixed. Accordingly, in the resultant mixture of the treatment liquids A and B, a chemical reaction is caused and an unnecessary precipitate is generated, so that the precipitate is attached to the wafer and becomes a cause of particles. Such a precipitate is attached to the inner wall of the treatment bath and is mixed into a treatment liquid used for the following treatments, whereby the precipitate is attached to the wafer and a bath wall and adversely affecting the treatment quality of the wafer. Furthermore, since recently complicated circuit patterns are formed on the surface of the wafer, even particles which have not been brought into question for a so-called bare wafer on which the above-noted complicated circuit patterns are not formed or a wafer on which a limited number of circuit patterns are formed, are undesirable for a wafer on which complicated circuit patterns are formed when such a wafer is treated in a single bath having a limited efficiency for replacing the treatment liquids.

On the other hand, when as a countermeasure against the above-noted disadvantages, the treatment liquid is prevented from remaining in the bath, the exchange of the treatment liquid and the cleaning of the bath take too much time and the productivity of the wafer is extremely impaired, so that the treatment of the wafer becomes unsuitable for practical use and a large amount of the treatment liquid becomes necessary, which leads to a remarkable rise of the treatment cost.

From this viewpoint, in the substrate treatment apparatus described in Patent Document 1, the chemical liquid treatment, flushing and drying are performed in individual treatment baths to solve the above-noted task. However, the apparatus is upsized and since the wafer is conveyed sequentially through the treatment baths, during conveying the wafer, the wafer is exposed to air and an oxide film may be generated on the surface of the wafer. Further, since in the cleaning device 109, the cleaning bath 111 and the drying chamber 112 are produced integrally, every time the wafer is conveyed into the cleaning bath, the wafer needs to pass through the drying chamber, so that the conveyance of the wafer becomes cumbersome. Separately, a drying bath 110 is also needed.

Further, in the substrate treatment apparatus described in Patent Document 2, due to the structure of the treatment bath and the treatment liquid supply line which are shown in the drawing, the replacing efficiency of the treatment liquids is limited, so that the treatment liquid remains in the bath and the above-noted precipitate might be generated. When the remaining amount of the treatment liquid will be reduced, the treatment requires a long time and moreover, a large amount of the treatment liquid becomes necessary. Further, the drying should be performed in another bath, and a series of treatments including the treatment of chemical liquids, flushing and drying cannot be performed in a single bath. It is further important that when the same amount of the treatment liquid is constantly supplied from the same position into the bath, the settlement of the liquid is caused in the treatment liquid. Even when the liquid supplying direction is changed, only the position of the settlement is changed and the settlement itself cannot be dissolved. It has become known that the settlement not only causes the above-noted particles, but also causes such a disadvantage that during replacing the treatment liquids a former treatment liquid remains easily.

Considering these tasks, the present inventors have found that by raising the replacing efficiency of the treatment liquids, particularly of a rinsing liquid in the treatment bath and by preventing the settlement of the treatment liquid in the bath, the remaining amount of the treatment liquid becomes extremely little, so that the total amount of the chemical liquid can be reduced and the productivity can be raised, and the chemical liquid treatment, flushing and drying can be performed in a single bath. Based on these findings, the present invention has been completed.

In other words, an object of the present invention is to provide a substrate treatment apparatus in which the treatment of various types of chemical liquids, flushing and drying can be performed in the same treatment bath.

### Means to Solve the Problems

(1) A substrate treatment apparatus according to the present invention includes a box-shaped treatment bath having an opening part at its upper side, and a cover body openably covering the opening part of the treatment bath. The cover body includes a drying chamber formed therein for storing and drying a substrate to be treated. The treatment bath is so formed that at least three of treatment liquid supply nozzle tubes are disposed at each of the opposed side wall faces thereof forming the box shape horizontally at specified intervals and these supply nozzle tubes are formed to be connected to a switching mechanism to supply a treatment liquid from the opposed side wall sides while alternately switching them at the opposed side wall faces.

(2) In an aspect of (1), it is preferred that at least one tube among the three supply nozzle tubes disposed at each of the opposed side wall faces be exclusively used for pure water.

(3) In another aspect of (1), it is preferred that the at least three supply nozzle tubes respectively include a hollow cylinder in which a plurality of injection openings are formed at specified pitches in at least one row in the longitudinal direction of the hollow cylinder, and each of these at least three supply nozzle tubes be attached to the opposed side wall faces while directing each of the injection openings to a substrate to be treated which is arranged in the vertical direction.

(4) In still another aspect of (1), it is preferred that in the treatment bath, a bottom wall be inclined from the horizontal direction by a specified angle and a discharge outlet be formed at a lower end of the inclined bottom wall.

(5) In another aspect of (1) to (4), it is preferred that in the treatment bath, an ultrasonic generating device be attached to an outer surface of the bottom wall.

(6) In still another aspect of (1), it is preferred that a plurality of injection nozzles be disposed in the drying chamber and these injection nozzles be connected to a dry vapor supply device for supplying a dry vapor containing submicron organic solvent mist.

### ADVANTAGES OF THE INVENTION

By including the above-noted features, the present invention provides the following advantages. According to an aspect of the present invention, since at least three supply nozzle tubes are respectively attached to each of the opposed side wall faces in the treatment bath, the settlement of the treatment liquid can be prevented in the bath.

For example, after the completion of the treatment of a specified chemical liquid A, the supply of the chemical liquid is stopped and by supplying pure water only from three supply nozzle tubes provided on any one of the opposed side wall faces, the chemical liquid A is purged for a specified time. Consequently, the supply of pure water from the three supply nozzle tubes from which pure water has been supplied first is stopped and by supplying pure water from three supply nozzle tubes provided on the other of the opposed side wall faces, the flow of the liquid in the bath is gradually changed to purge the chemical liquid A which has been settled in the bath and could not be purged. Further, by supplying pure water from all of the supply nozzle tubes to increase the flow amount and flow rate of pure water, the substrate to be treated and the inside of the bath can be cleaned in a short time. This is because the direction of the supplying of pure water is changed at a stretch, but the flow rate is changed not at a stretch but gradually, so that the settlement caused first is gradually moved and the remained chemical liquid can be swiftly purged. By performing the same treatment and cleaning in the treatment with the chemical liquid B as those in the treatment with the chemical liquid A and by repeating such treatment and cleaning, the exchange of the chemical liquid and cleaning liquid is speeded up and a series of treatments including the treatment of chemical liquids, flushing and drying can be performed in the same treatment bath.

Since between a supply nozzle tube for supplying both a chemical liquid and pure water and a treatment liquid supply source, a mixing device which makes the concentration of the treatment liquid to a specified concentration is connected and treatment liquids are supplied from the mixing device into the bath, a large amount of pure water cannot be supplied from such a supply nozzle tube during the exchange of the treatment liquids. However, according to the present invention, by providing supply nozzle tubes used exclusively for pure water, pure water can be supplied not through the mixing device into the bath. In addition by supplying pure water also from other supply nozzle tubes, a large amount of pure water is supplied into the bath in a short time. With the large amount of pure water, the substrate to be treated and the inside of the bath can be cleaned.

Since the cover body covers openably the opening part of the treatment bath and in the inside thereof, the drying chamber is formed, the cover body can be moved upward or in the side direction from the opening part during the treatment of the substrate, so that the contamination of the cover body by the chemical liquid can be avoided. Further, since during the drying, the opening part of the treatment bath is covered by the cover body and the substrate to be treated is pulled up from the treatment bath and is dried in the drying chamber, the substrate is not exposed to air during the moving thereof, so that the generation of an oxide film on the surface of the substrate is prevented and high quality drying can be performed.

According to a preferred aspect of the present invention, by providing supply nozzle tubes used exclusively for pure water, pure water can be supplied efficiently.

Since between a supply nozzle tube for supplying both a chemical liquid and pure water and a treatment liquid supply source, a mixing device which makes the concentration of the treatment liquid to a specified concentration is connected and treatment liquids are supplied from the mixing device into the bath, a large amount of pure water cannot be supplied from such a supply nozzle tube during the exchange of the treatment liquids. However, according to the present invention, by providing supply nozzle tubes used exclusively for pure water, pure water can be supplied not through the mixing device and consequently in a large amount into the bath. In addition by supplying pure water also from other supply nozzle tubes, a large amount of pure water is supplied into the bath in a short time. With the large amount of pure water, the wafer and the inside of the bath can be rapidly cleaned.

According to another preferred aspect of the present invention, by using a supply nozzle tube having a simple structure, pure water or a chemical liquid can be efficiently supplied to the substrate to be treated. Moreover since the flow amount can be increased in the bath and a flow in a specified direction which has a large flow rate can be formed, not only the settlement of the cleaning liquid in the bath can be prevented, but also the replacing efficiency can be improved.

According to still another preferred aspect of the present invention, since the bottom wall is inclined from the horizontal direction by a specified angle, the permeability of the ultrasonic is improved. Furthermore, since a discharge outlet is formed at a lower end of the bottom wall, the sediment accumulated on the bottom of the bath slides down along the inclined bottom wall surface and can be easily discharged out of the discharge outlet. Therefore, each time when the treatment liquid is exchanged, the sediment on the bottom of the bath is discharged out of the bath, so that it is possible to keep the bath clean.

According to still another preferred aspect of the present invention, the substrate to be treated can be subjected to not only a chemical treatment with a treatment liquid, but also to a physical treatment by an ultrasonic vibration, and by a combination of these treatments, a high quality treatment can be performed.

According to still another preferred aspect of the present invention, a dry gas containing submicron organic solvent mist is supplied from a dry vapor supply device into the drying chamber. Therefore, since mist contained in the organic solvent vapor is submicron in size, the number of mist particles of the organic solvent can be large without increasing the amount of the organic solvent. Further, while the surface area of an individual mist particle is small, in line with the large number of mist particles, the total surface area of mist particles, which is a total sum of the surface area of an individual mist particle, is large. As a result, a large amount of submicron mist particles can be injected to the surface of the substrate, so that a cleaning liquid attached to the substrate can be efficiently replaced by the large amount of submicron organic solvent mist particles. Moreover, even when a large number of substrates having a large diameter are inserted into the treatment bath, since a plurality of injection nozzles are disposed, and consequently submicron mist particles can rapidly intrude between the substrates, not only the efficiency of the drying can be improved, but also the treatment time can be shortened. Accordingly, the cause of a water mark on the substrate surface can be reduced to extremely little or almost nothing. Further, the attaching of particles to the substrate can be prevented, and moreover the speed of the drying is enhanced, so that the reattaching of particles can be also prevented.

### BRIEF DESCRIPTION OF THE DRAWINGS

FIG. 1 is a schematic plan layout pattern of a substrate treatment apparatus according to an embodiment of the present invention.

FIG. 2 is a cross-sectional view showing the treatment apparatus.

FIG. 3 shows a treatment bath constituting the treatment apparatus shown in FIG. 2. FIG. 3A is a sectional side view shown in the direction indicated by the arrow X in FIG. 2; FIG. 3B is a top view; and FIG. 3C is a cross-sectional view along the IIIC-IIIC line shown in FIG. 3A.

FIG. 4 shows a supply nozzle tube disposed in the treatment bath shown in FIG. 3. FIG. 4A is a side view; FIG. 4B is a partially enlarged top view shown in the direction indicated by the arrow Y in FIG. 4A; and FIG. 4C is a cross-sectional view along the IVC-IVC line shown in FIG. 4B.

FIG. 5 is a schematic of the pipe.

FIG. 6 is a cross-sectional view showing a treatment process in the treatment apparatus.

FIG. 7 is a cross-sectional view showing a treatment process in the treatment apparatus.

FIG. 8 is a cross-sectional view showing a treatment process in the treatment apparatus.

FIG. 9 is a cross-sectional view showing a treatment process in the treatment apparatus.

FIG. 10 is an explanatory drawing for a treatment process showing a timing of supplying various types of treatment liquids.

FIG. 11 is an explanatory drawing for a treatment process showing a timing of supplying various types of treatment liquids.

FIG. 12 is a plan view showing a substrate treatment apparatus according to a related art.

FIG. 13 is a cross-sectional view showing a cleaning device constituting the substrate treatment apparatus shown in FIG. 12.

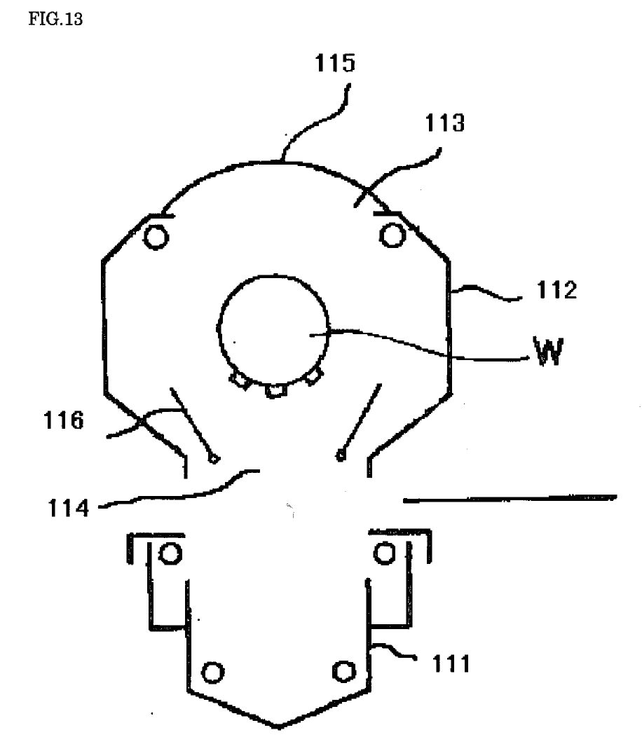

FIG. 14 is a schematic view showing a substrate treatment apparatus according to a related art.

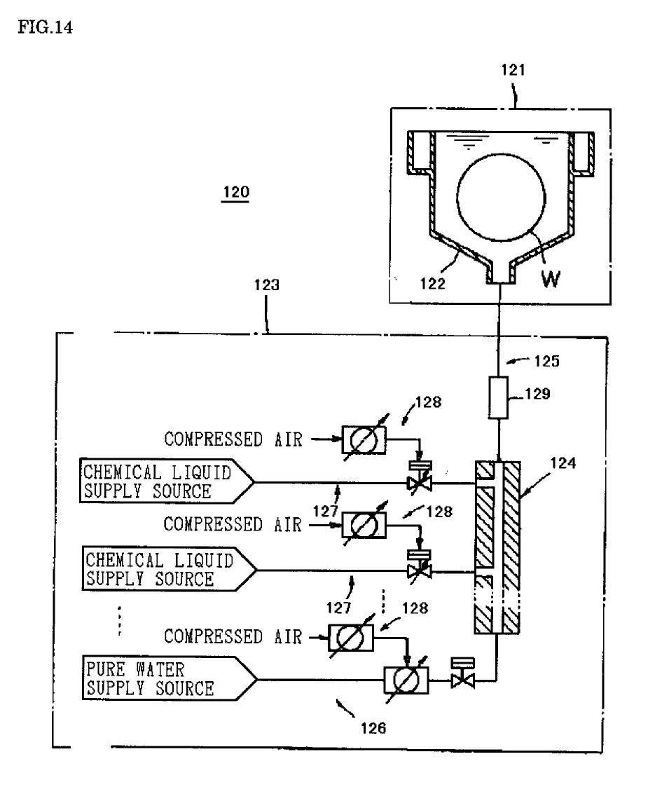

### REFERENCE NUMERALS

1 Substrate treatment apparatus
10 Treatment device
11 Treatment bath
12 Inner bath
12a Bottom wall
12b to 12e Side walls
13 Outer bath
14, 14a to 14c, 14a′ to 14c′ Supply nozzle tubes
17, 18 Injection openings
19, 20 Discharge outlet
21 Cover body
23 Drying chamber
30 Ultrasonic generating device
32 Ultrasonic generator
35 Dry vapor supply device
36 Vapor generating bath
40 Mixing device
41, 41a Pure water supply source
42 to 46 Chemical liquid supply source
38, 39 Inert gas supply source

### DESCRIPTION OF THE PREFERRED EMBODIMENTS

Hereinafter, preferred embodiments of the present invention are described referring to the drawings. The following embodiments only exemplify a substrate treatment apparatus for embodying the technical concept of the present invention. Therefore, it is not intended to limit the scope of the present invention to these embodiments of the substrate treatment apparatus, but other embodiments contained in the Claims appended hereto are equally applicable.

### First Embodiment

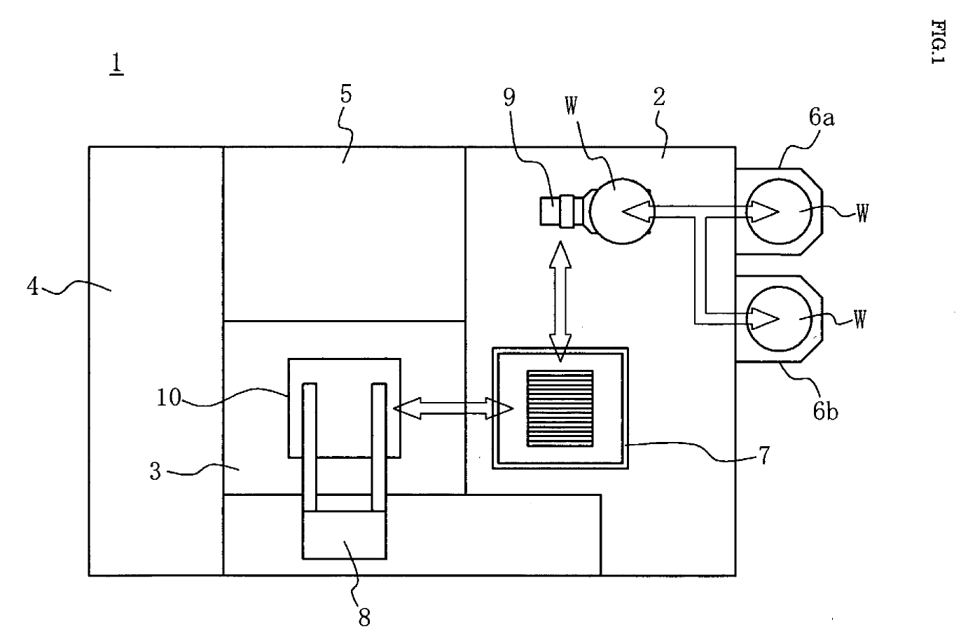

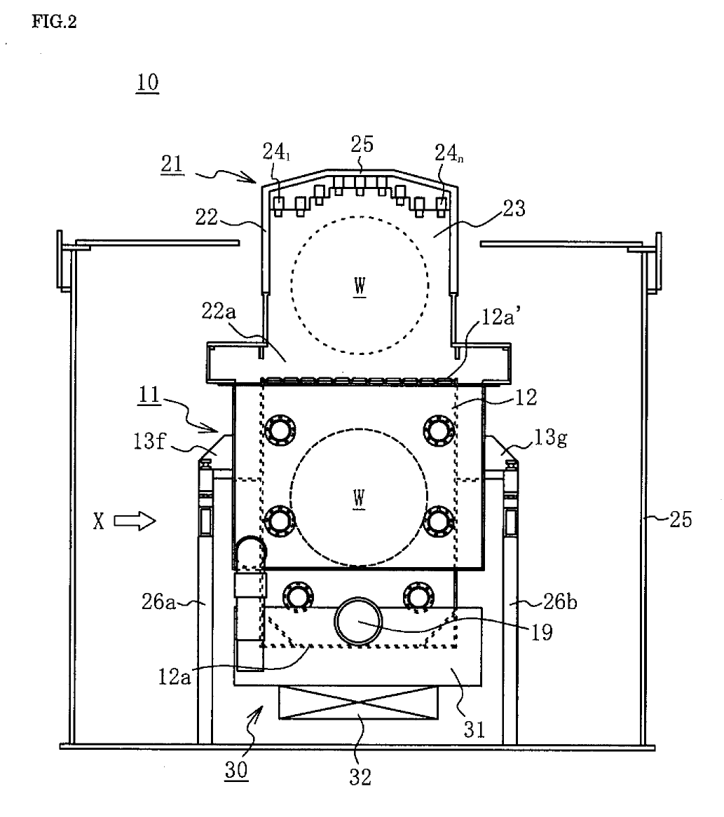

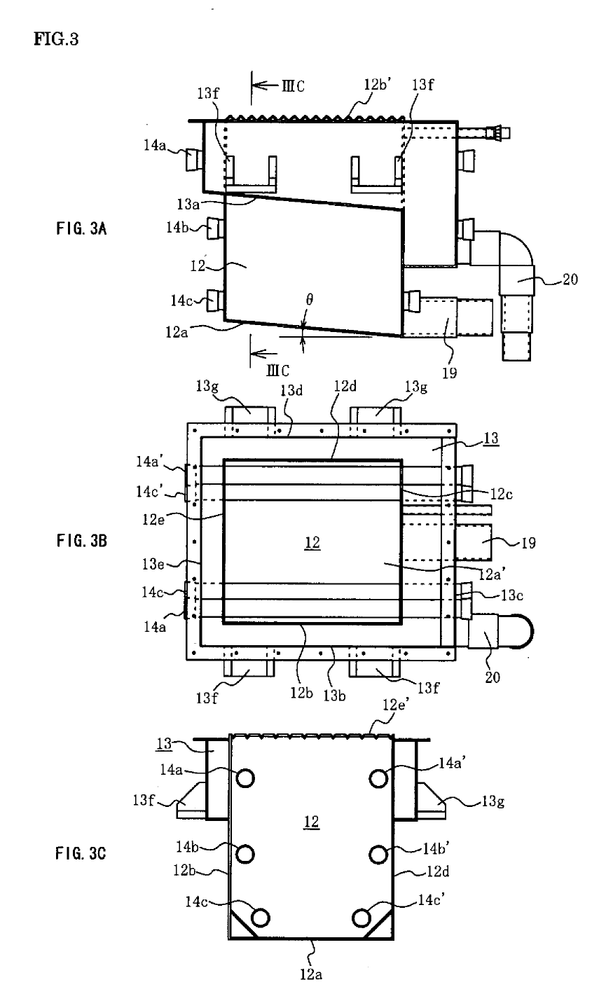

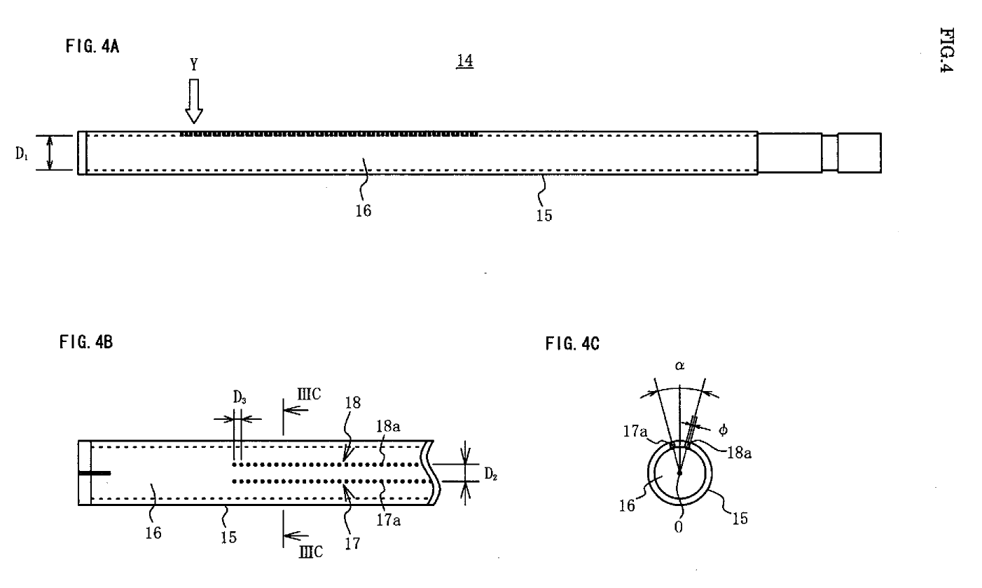

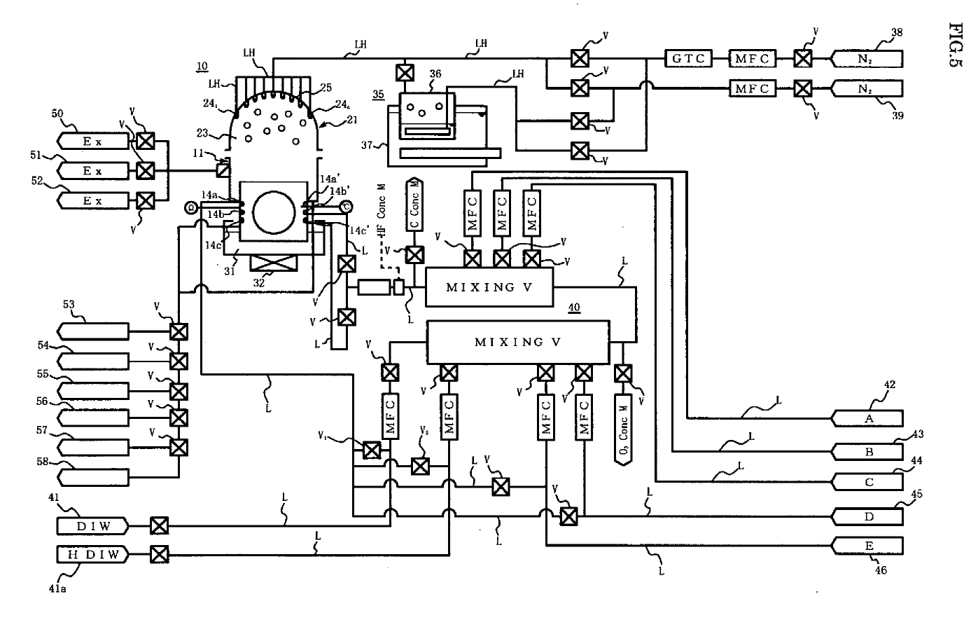

FIG. 1 is a schematic plan layout pattern of a substrate treatment apparatus according to an embodiment of the present invention. FIG. 2 is a cross-sectional view showing the treatment apparatus. FIG. 3 shows a treatment bath constituting the treatment apparatus shown in FIG. 2; FIG. 3A is a sectional side view shown in the direction indicated by the arrow X in FIG. 2; FIG. 3B is a top view; and FIG. 3C is a cross-sectional view along the IIIC-IIIC line shown in FIG. 3A. FIG. 4 shows a supply nozzle tube disposed in the treatment bath shown in FIG. 3; FIG. 4A is a side view; FIG. 4B is a partially enlarged top view shown in the direction indicated by the arrow Y in FIG. 4A; and FIG. 4C is a cross-sectional view along the IVC-IVC line shown in FIG. 4B. FIG. 5 is a schematic of the pipe.

A substrate treatment apparatus 1 is provided with a treatment device 10 in which a series of treatments including from the chemical liquid treatment to the cleaning as a surface treatment of various types of substrates, such as a semiconductor wafer, a substrate for a liquid crystal display device, a substrate for a recording disc, and a substrate for a mask, can be performed in one bath. Hereinafter, a semiconductor wafer (hereinafter, referred to as “wafer”) is described as a representative of various types of substrates.

Hereinafter, the term “treatment liquid” is used as a general term including a chemical liquid for an etching treatment of a wafer surface and a cleaning liquid for cleaning a wafer surface and inside the treatment bath.

Further, “vapor” indicates generally “gas”, however, in the technical field of substrate treatment, a substance containing fine liquid particles (mist) besides gas, such as a dry air, is also expressed as “vapor”, so that herein and in Claims, a substance containing fine liquid particles (mist) besides gas will be also referred to as “vapor”.

As shown in FIG. 1, the substrate treatment apparatus 1 includes a treatment device 10 positioned in an approximately central part 3, a treatment liquid supply part 4 positioned around the treatment device 10 and supplying various types of treatment liquids to the treatment device 10, a pipe area 5 connecting the treatment device 10 with the supply part 4, and a conveying part 2 conveying a wafer W into or out of the treatment device 10.

A plurality of wafers W, for example 25 pieces of wafers having a diameter of 300 mm are stored as one set in a plurality of containers, for example in two front open unified pods (FOUPs) 6a, 6b, conveyed by a conveying robot 9 along a direction shown by the arrow in FIG. 1 to an HV unit 7. Here, the array of the wafers W is changed from the horizontal direction to the vertical direction and the wafers W are transferred to a vertical conveyer 8 including a wafer chuck part to be conveyed into the treatment device 10. The wafers W which have been subjected to the treatment are conveyed out through the reverse route. At this time, since a chuck which has gripped the wafers W before the treatment grips also the wafers W after the treatment, a chemical liquid is attached to the chuck while inserting the wafers W into the treatment device 10. Consequently the chemical liquid may be attached to the wafers W after the treatment through the wafer chuck. Therefore, it is necessary to clean the wafer chuck during the treatment of the wafers W. However, since a widely known robot mechanism and conveying mechanism including also used for wafer chuck cleaning are used here, the explanations thereof are omitted.

As shown in FIG. 2, the treatment device 10 includes a treatment bath 11 having a size which can accommodate a specified number of wafers W, for example the above-noted 50 pieces, and a treatment liquid, a cover body 21 openably covering an upper opening part 12a′ of the treatment bath 11, and an ultrasonic generating device 30 mounted in the bottom part of the treatment bath. These elements are accommodated in a box-shaped accommodating case 25. In the accommodating case 25, footstools 26a, 26b are provided upright from the floor plate and by the footstools, the treatment bath 11 is supported and fixed. In the inside of the cover body 21, a drying chamber 23 is provided. The cover body 21 is moved up and down by a moving mechanism (not shown) to cover openably the opening part 12a′ of the treatment bath.

As shown in FIG. 3, the treatment bath 11 includes a box-shaped inner bath 12 which is formed with an approximate quadrangle-shaped bottom wall 12a and four side walls 12b to 12e provided upright from the circumference of the bottom wall 12a, and of which upper part is opened. The treatment bath 11 also includes an outer bath 13 which is formed with a bottom wall 13a and surrounded by four side walls 13b to 13e provided with a predetermined width from the periphery of the inner bath 12. On the side walls 13b, 13d of the outer bath 13, attaching parts 13f, 13g for attaching the outer bath 13 to the footstools 26a, 26b are formed.

As shown in FIG. 3A, the bottom wall 12a of the inner bath 12 is inclined by a specified angle θ, e.g., 3° from the horizontal direction. By inclining the bottom wall, when a below-described ultrasonic generating device 30 is attached to the bottom wall, ultrasonic cleaning can be efficiently performed. In addition, the discharge of a liquid can be smoothly performed.

In the upper end part of each of the side walls 12b to 12e, V-shaped grooves (in FIG. 3, grooves 12b′, 12e′ of the side walls 12b, 12e are shown) are formed. By providing these grooves, a treatment liquid can overflow out of the inner bath 12 to the outer bath 13 over every side wall evenly without deviating to a side wall.

For shortening the discharge time when the discharge of the liquid is necessary, the discharge outlet 19 is formed to have a large diameter, such as 75 mm. Also, on the bottom wall 13a of the outer bath 13, a discharge outlet 20 having a diameter of e.g., 50 mm is formed.

Between the opposed side walls 12b, 12d, a plurality of supply nozzle tubes (in FIG. 3, three tubes per one side wall) 14a to 14c and 14a′ to 14c′ including a hollow cylinder are provided horizontally at specified intervals.

Each of the supply nozzle tubes 14a to 14c and 14t′ to 14c′ has the same configuration and one of these tubes is shown in FIG. 4. The supply nozzle tube 14 includes a cylinder having a specified diameter D₁ and a specified length in which injection openings 17, 18 including a plurality of openings 17a, 18a are formed in the longitudinal direction thereof in two rows which are separated from each other by a specified distance D₂, wherein the openings 17a, 18a are each formed at specified pitches D₃ in one row. D₁ is, for example 20 mm; D₂ is, for example 6.8 mm which is determined by the following angle α; D₃ is, for example 5.0 mm; and the length of the supply tube is a little longer than the width of the treatment bath 10.

The injection openings 17, 18 have a specified diameter φ and are formed at positions at the specified angle α from the center of the cylinder. The diameter φ is, for example 1 mm and the angle α is, for example 30°.

The supply nozzle tubes 14a to 14c, 14a′ to 14c′ are provided on the opposed side walls 12b, 12d in such a manner that the injection openings 17a, 18b turn to a specified direction. In other words, on one side wall 12b, three supply nozzle tubes 14a to 14c are provided substantially horizontally in upper, middle and lower parts of the wall 12b at specified intervals. In this arrangement, the injection openings 17a, 18a of the supply nozzle tube 14c in the lower part is inclined upward by 60°, the supply nozzle tube 14b in the middle part is inclined upward by 20°, and the supply nozzle tube 14a in the upper part is inclined downward by 45°. Also, on the other side wall 12d, three supply nozzle tubes 14a′ to 14c′ are provided in the same manner. By setting the above-noted angles, when the wafer is stored in the bath, each of the injection openings turns to substantially the center of the wafer.

Among the supply nozzle tubes, the supply nozzle tubes 14a, 14a in the upper part are used exclusively for a pure water supply and the other supply nozzle tubes 14b, 14c, 14b′, 14c′ are used for supplying both a chemical liquid and pure water.

By providing the supply nozzle tubes 14a to 14c, 14a to 14c′ respectively on the opposed side walls 12b, 12d, a flow channel in a specified direction can be formed in the bath.

For example, after the completion of a treatment of a specified chemical liquid A, the supply of the chemical liquid is stopped and first, pure water is supplied only from the three supply nozzle tubes 14a to 14c on any one of the two side walls (for example, the left side wall 12b in FIG. 3C) to purge the chemical liquid A in the inner bath 12 for a specified time. Next, the supply of pure water from the supply nozzle tubes 14a to 14c is stopped and instead the supply of pure water from the other three supply nozzle tubes 14a′ to 14c′ on the other of the two side walls (for example, the right side wall 12d in FIG. 3C) is started, whereby the flow in the bath is gradually changed to further purge the specified chemical liquid A which is settled and remains unpurged in the bath. Further, by supplying pure water from all of the supply nozzle tubes 14a to 14c, 14a′ to 14c′ to increase not only the flow amount, but also the flow rate of pure water, the wafer W and the inside of the inner bath 12 can be cleaned in a short time. This is because the direction of the supplying of pure water is changed at a stretch, but the flow rate is changed not at a stretch but gradually, so that the settlement caused first is gradually moved and a remained chemical liquid can be swiftly purged. By performing processing and cleaning with the chemical liquid B in the same manner and by repeating such treatment and cleaning, the exchange of the chemical liquid and cleaning liquid is speeded-up and a series of treatments including the treatment of chemical liquids, flushing and drying can be performed in the same treatment bath.

Further, in the above description, pure water is supplied from a right supply nozzle tube or from a left supply nozzle tube alternatively by switching the supply; however, for example, when the supply nozzle tubes 14b, 14c (or supply nozzle tube 14a) in the lower (or upper) part among the supply nozzle tubes 14a to 14c provided on the side wall 12b and the supply nozzle tube 14i′ (or supply nozzle tubes 14b′, 14c) in the upper (or lower) part among the supply nozzle tubes 14a′ to 14c′ provided on the side wall 12d are simultaneously used, a whirlpool-shaped flow can be formed in the treatment bath 11. By supplying pure water while changing the supplying direction optionally, the cause of the settlement in the treatment bath 11 can be rendered difficult.

The number of the supply nozzle tubes and the angles of the injection openings at providing the supply nozzle tubes are not limited to the above-noted number and angles and may be optionally selected.

As shown in FIG. 2, at the bottom 12a of the treatment bath 11, an ultrasonic generating device 30 is mounted. The ultrasonic generating device 30 includes an ultrasonic generator 32 a shallow-bottomed container 31 for pooling an ultrasonic transfer medium, such as water. As the ultrasonic generator 32, an oscillator emitting an ultrasonic having a specified frequency, such as 10 KHz to several MHz is used.

By mounting the ultrasonic generator 30 at the bottom 12a of the treatment bath 11, an ultrasonic irradiated from the generator is transmitted through water and the bottom 12a of the inner bath 12 and transferred to the treatment liquid. Further, the ultrasonic vibrates the treatment liquid and acts as a physical force on the surface of the wafer to remove particles, such as foreign matters and contaminants attached to the surface of the wafer.

As shown in FIG. 2, the cover body 21 includes a box-shaped container 22 having an opening part 22a in the lower part thereof and a closed part in the upper part thereof and having such a size that in the inside thereof a plurality of wafers W can be received, and the inside of the container is used as the drying chamber 23. The cover body 21 can be moved in a vertical or horizontal direction by a moving mechanism (not shown).

In the upper part of the box-shaped container 22, a substantially arch-shaped ceiling surface 25 is formed. On the ceiling surface 25, a plurality of injection nozzles 24₁ to 24ₙ for injecting a dry gas are disposed in a line at substantially regular intervals on the four sides.

Next, referring to FIG. 5, the connection by the piping between the treatment device and the supply part of various types of chemical liquids is described. FIG. 5 shows a schematic of the pipe and the line of the pipe, divided roughly into a treatment liquid supply line and a discharged liquid treating line.

(i) Treatment Liquid Supply Line

As the treatment liquid supply line, pure water supply sources 41, 41a, various types of chemical liquid supply sources 42 to 46 and inert gas supply sources 38, 39 are disposed around the treatment device 10.

The pure water supply sources 41, 41a include a pure water supply source 41 for supplying pure water at normal temperature and a warm pure water supply source 41a for supplying pure water heated to a specified temperature of 25 to 65° C. The chemical liquid supply source includes a chemical liquid A supply source 42 for supplying, e.g., HCl, a chemical liquid B (e.g., H₂O₂) supply source 43, a chemical liquid C (e.g., HF) supply source 44, a chemical liquid D (e.g., NH₄O₄) supply source 45, and a chemical liquid E (e.g., O₃+pure water) supply source 46.

Each of the above-noted supply sources 41 to 46 is connected to the mixing device 40 by a pipe L. Among them, the pure water supply sources 41, 41a are connected via valves V₁, V₂ to directly supply pure water to the supply nozzle tubes 14a, 14a′ of the treatment bath 11, not through the mixing device 40. By this connection, a large amount of pure water can be supplied from the pure water supply sources 41, 41a to the treatment bath, not through the mixing device 40.

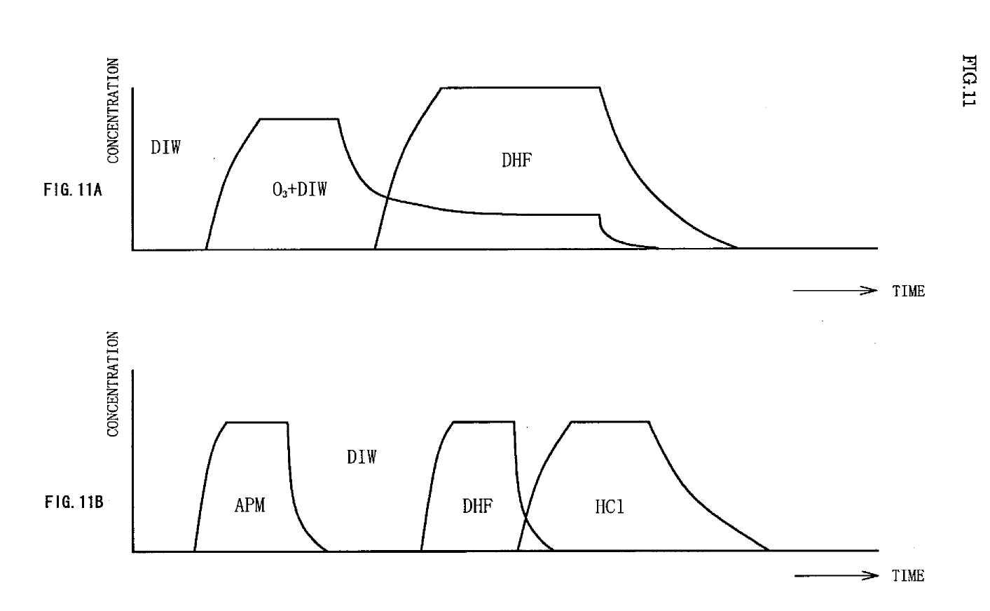

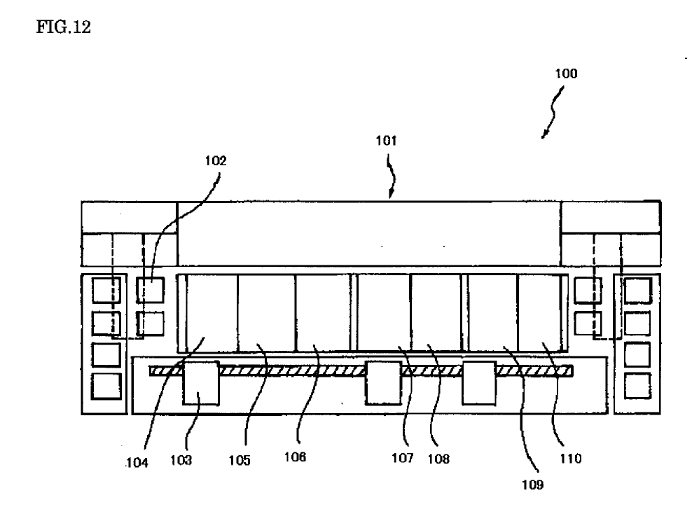

The chemical liquid supply sources 42 to 46 are connected to the mixing device 40 by the pipe L and the mixing device 40 is connected to the supply nozzle tubes 14b, 14c, 14b′, 14c′ of the treatment bath 11 by the pipe L. Further, a chemical liquid supplied from each of the chemical liquid supply sources 42 to 46 is adjusted to a specified concentration by mixing a single chemical liquid or a plurality of chemical liquids with pure water, and is supplied to the treatment bath 11. Mixing ratios of pure water and chemical liquids used in the below-described various treatment processes (FIG. 11, FIG. 12) are as follows: a chemical liquid APM is prepared by mixing chemical liquids and pure water in a mixing ratio of NH₄OH:H₂O₂:H₂O=1:2:50 to 1:1:200; a chemical liquid DHF is prepared by mixing chemical liquids and pure water in a mixing ratio of HF:H₂O=1:100 to 1:1000; a chemical liquid HCl is prepared by mixing chemical liquids and pure water in a mixing ratio of HCl:H₂O=1:100 to 1:1000; and the concentration of O₃ is 0 to 10 ppm.

Inert gas supply sources 38, 39 supplying an inert gas, such as nitrogen gas, are connected via a valve V to injection nozzles 21₁ to 24ₙ and to a dry vapor supply device 35 by the pipe L.

Each of the injection nozzles 21₁ to 24ₙ is cone-shaped and at a tapered top part thereof, an opening from which a dry gas is injected is formed. To each of the injection nozzles 21₁ to 24ₙ, a heater (not shown) is attached. Since each injection nozzle itself is already known, specific descriptions of the nozzle will be omitted. Further, with respect to a pipe LH and a branched pipe branched from the pipe LH, a heater (not shown) is attached to a circumference surface of the pipe. As the heater, for example a belt heater is used. The heater is connected to a CPU (not shown) and controlled by the CPU.

From the dry vapor supply devices 38, 39, an inert gas (carrier gas) is supplied to the bottom part of a vapor generating bath 36 and the dry vapor supply device 35 generates bubbles (bubbling) in an IPA liquid pooled in the vapor generating bath 36 to generate an IPA vapor including an IPA gas and mist. A vapor derived from a vapor generating bath 37 is led via a static mixer (not shown) to the pipe LH and is supplied from the vapor generating bath 36 to the injection nozzles 21₁ to 24ₙ as a gas mixture including a carrier gas and an IPA vapor. The static mixer (not shown) is provided for accelerating a mixing degree of a gas mixture including a carrier gas and an IPA vapor to homogenize the gas mixture.

By bubbling the IPA liquid using an inert gas, a gas mixture of an inert gas with an IPA vapor including IPA mist and a gas having a concentration less than a saturated concentration thereof in the IPA vapor, can be obtained. Since the temperature of the gas mixture is so controlled to be kept at the same temperature or to be elevated gradually until the gas mixture is released from the injection nozzle, IPA is gradually vaporized from the surface of the IPA mist during the moving of the gas mixture and consequently, the particle diameter of the mist becomes smaller, so that a dry gas including submicron IPA mist can be easily obtained. As the organic solvent, besides IPA, an organic solvent selected from the group consisting of organic compounds, such as diacetone alcohol, 1-methoxy-2-propanol, ethylene glycol, 1-propanol, 2-propanol, and tetrahydrofuran, is used.

By using this dry gas, since the mist contained in the vapor of an organic solvent are submicron in size, the number of mist particles of the organic solvent can be large without increasing the amount of the organic solvent. Therefore, while the surface area of an individual mist particle is small, in line with the large number of mist particles, the total surface area of mist particles, which is a total sum of the surface area of an individual mist particle, is large.

Further, since a large amount of submicron mist can be injected to the surface of the wafer, a cleaning liquid attached to the wafer can be efficiently replaced by the large amount of submicron organic solvent mist. As a result, along with the adjustment of the plurality of supply nozzles and the amount of a carrier N₂, even when a large number of wafers having a large diameter are inserted into the treatment bath, since the submicron mist can rapidly intrude between the substrates, not only the efficiency of the drying can be improved, but also the treatment time can be shortened, so that the cause of a water mark on the substrate surface can be reduced to extremely little or almost nothing. Further, the attaching of particles to the substrate can be prevented. Moreover, since the speed of the drying is enhanced, the reattaching of particles can be also prevented.

From the inert gas supply sources 38, 39, nitrogen gas N₂ is supplied to the pipe LH as an inert gas. The pipe LH is also controlled to a specified temperature by a belt heater. The nitrogen gas N₂ is used not only for diluting a gas mixture of an inert gas and an organic solvent vapor from the vapor generating bath 36, but also for purging the inside of the treatment bath and for finish-drying. As the inert gas, besides nitrogen gas N₂, an inert gas selected from the group consisting of argon, helium and the like can be used. MFC shown in FIG. 5 represents a flow meter.

(ii) Discharged Liquid Treatment Line

The discharged liquid treatment line includes liquid treatment equipment for treating chemical liquids and water, and gas treatment equipment for treating a gas, such as a dry gas. The liquid treatment equipment includes a pure water treatment part 53, an alkali treatment part 54, an acid treatment part 55, an HF treatment part 56, an organic treatment part 57, and an organic gas treatment part 58. The gas treatment equipment positioned over the bath includes an organic substance treatment part 50, an acid treatment part 51, and an alkali treatment part 52. Each of the treatment equipments 50 to 58 is connected to the treatment device 10.

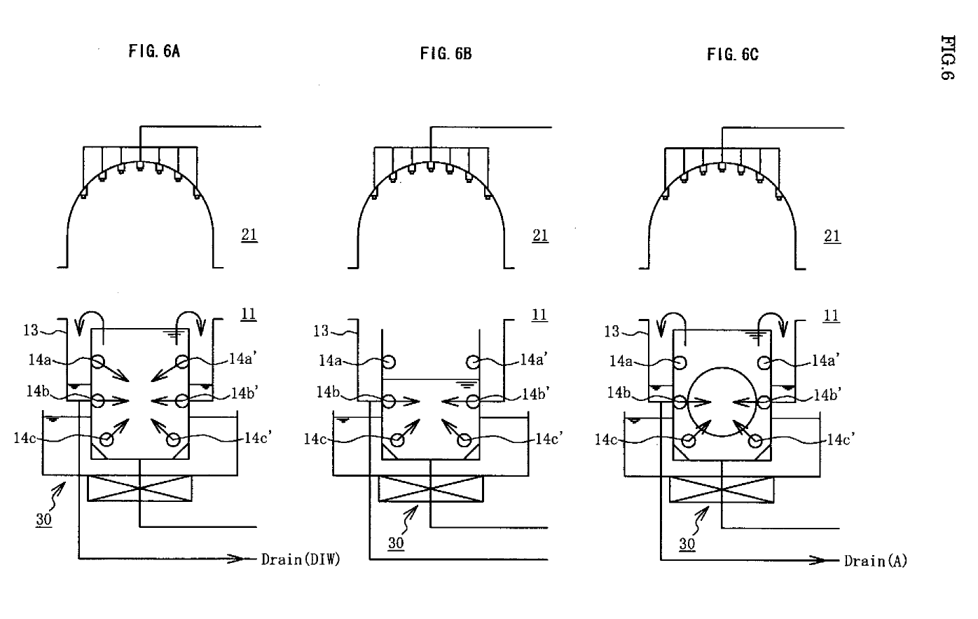

Next, a series of treatments of the wafer including the treatment of chemical liquids, cleaning and drying using this treatment device are described referring to FIG. 5 to FIG. 9. First, pure water DIW is supplied to the inner bath 12 of the treatment bath 11 from the pure water supply source 41 to clean the inner bath. At this time, the cover body 21 stands by in the upper part or upper side part of the treatment bath 11 (FIG. 6A).

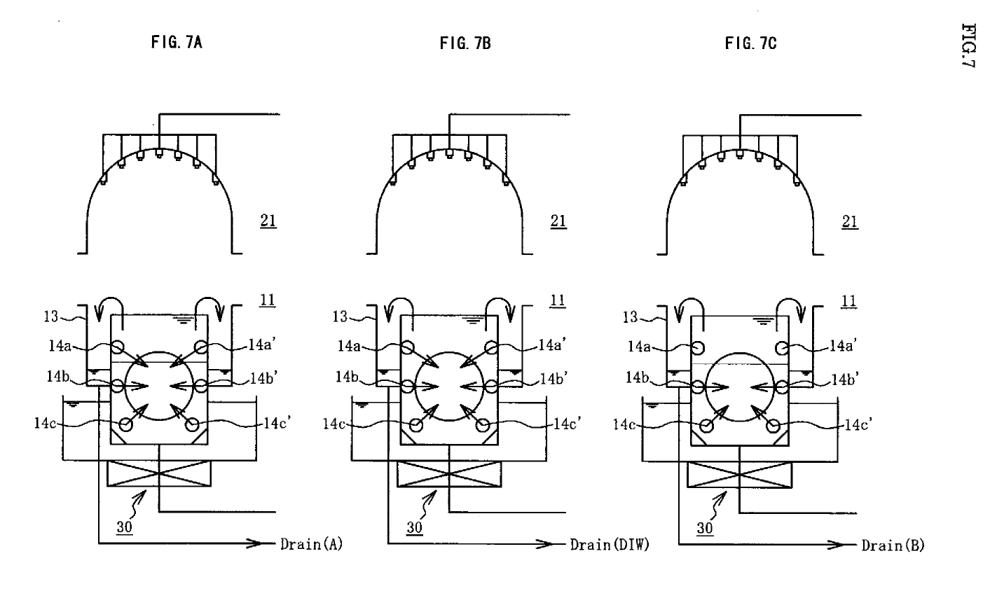

After the cleaning of the inside of the bath, the pure water DIW is discharged and a chemical liquid A is supplied from a chemical liquid supply source, for example the supply source 42 to the supply nozzle tubes 14b, 14c, 14b′, 14c′ in the bath (FIG. 6B). After the chemical liquid A is pooled in the bath 12, the wafer W is immersed in the chemical liquid A to be treated (FIG. 6C). After the completion of the treatment of the chemical liquid A, pure water is supplied from the pure water supply source 41 through the supply nozzle tubes 14a to 14c on one side wall and after a specified time, the supply of pure water is stopped. Subsequently, pure water is supplied through the supply nozzle tubes 14a′ to 14c′ on the other side wall. Lastly, the pure water DIW is supplied all at once through the supply nozzle tubes 14a to 14c, 14a′ to 14c′ (FIG. 7A).

After the completion of the cleaning (FIG. 7B) with the pure water DIW, a chemical liquid B is supplied from a chemical liquid supply source, for example the supply source 43 to the supply nozzle tubes 14b, 14c, 14b′, 14c′ to perform the treatment with the chemical liquid B and the cleaning with pure water (FIG. 7C). Afterward, in the same manner, optionally the treatments with chemical liquids C and D are performed.

After the completion of the treatment with the last chemical liquid, for example the chemical liquid D, pure water is supplied from the pure water supply sources 41, 41b through all of the supply nozzle tubes 14a to 14c, 14a′ to 14c′ to clean the wafer W.

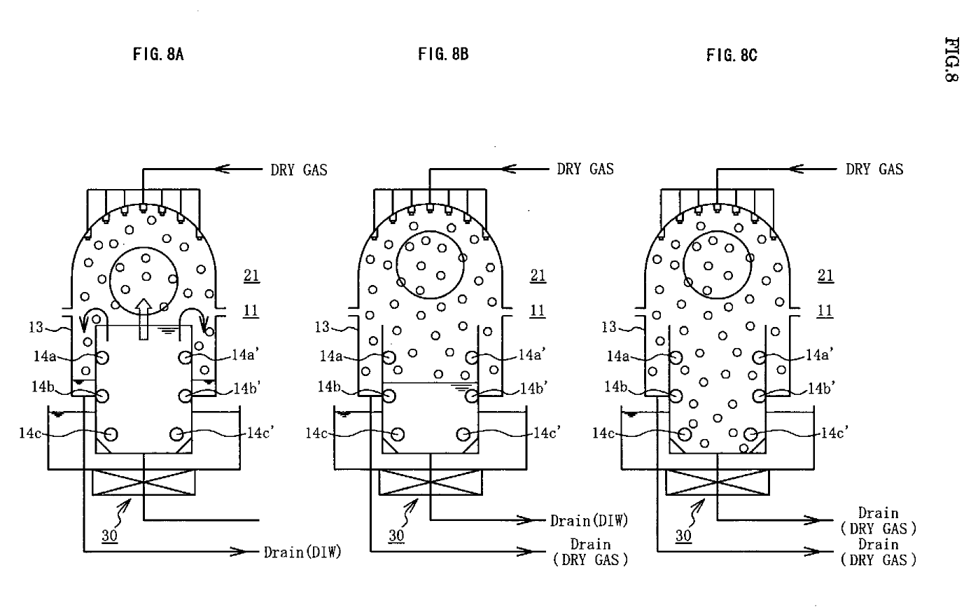

After the completion of this cleaning, the wafer W is pulled up out of the treatment bath 11 and is stored in the drying chamber 23 in the cover body 21, and a dry gas containing micro mist of IPA is injected through the injection openings 24₁ to 24ₙ to the wafer (FIG. 8A).

Next, the discharge outlet 19 (see FIG. 2, FIG. 3) is fully opened to discharge rapidly the pure water in the inner bath 12. During the discharge, a dry gas of IPA containing micro mist is continued to be supplied through the injection openings 24₁ to 24n to dry the wafer W (FIG. 8B, FIG. 8C).

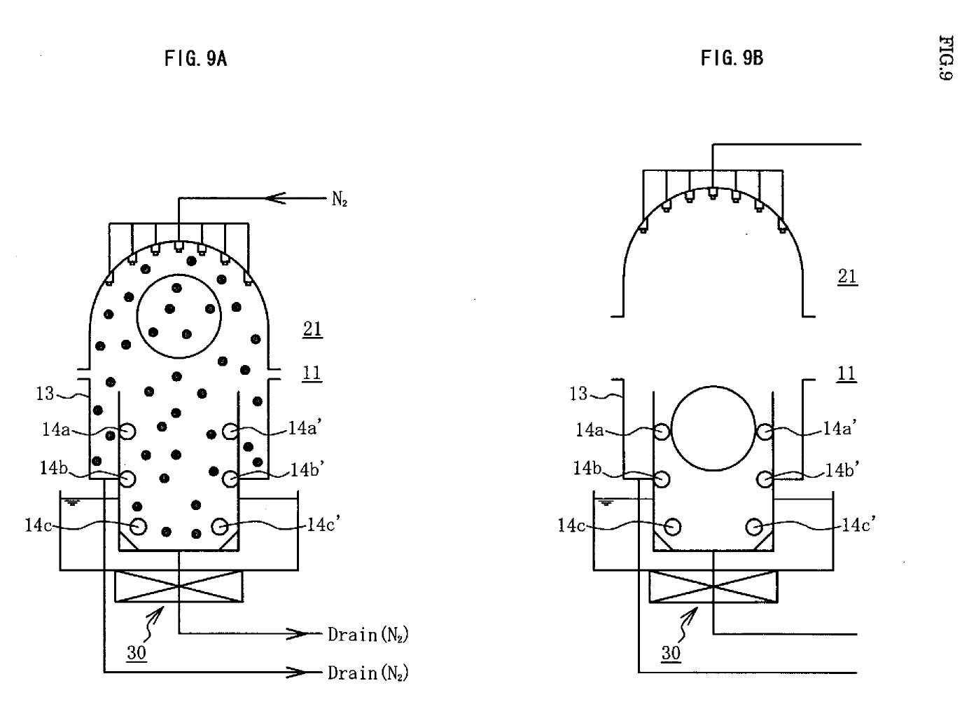

After the completion of this drying, nitrogen gas (N₂) is supplied from the inert gas supply sources 38, 39 to the drying chamber 23 (FIG. 9A) and thereafter, the wafer W is taken out of the drying chamber 23 to complete the treatment (FIG. 9B).

In the above-noted treatment process, the treatment using a general chemical liquid A, B is described; however, more specifically, the following chemical liquid treatment process can be performed. Hereinafter, a representative treatment process is described.

### (1) Dirt Removal Treatment Process

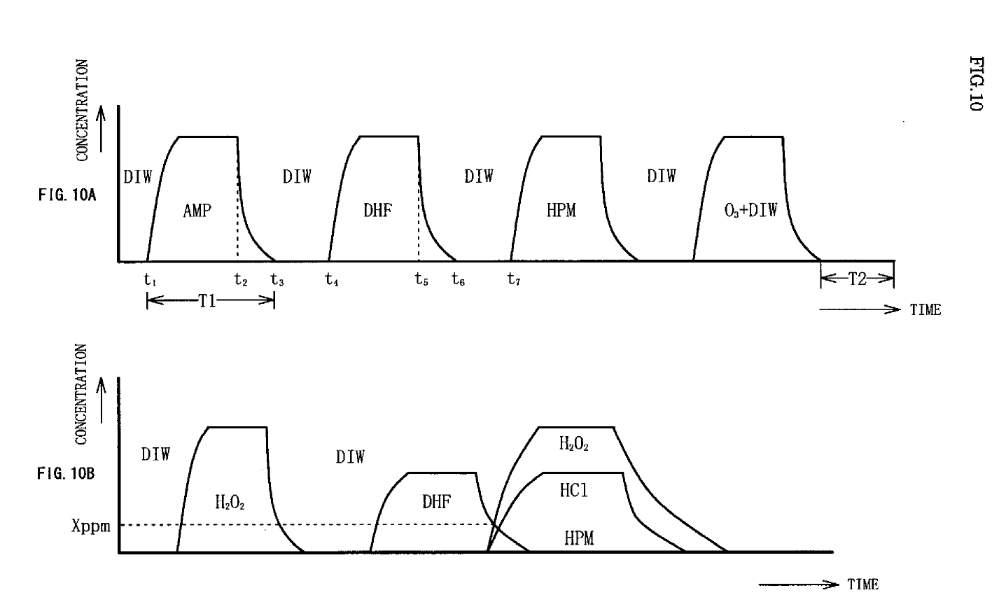

A treatment process shown in FIG. 10A is a process for removing organic dirt, particles, oxide films, and metal impurities which are attached to the wafer and is usually referred to as an RCA process. Here, a process for casting the wafer into pure water DIW is described. In this treatment process, first, pure water DIW is supplied from the pure water supply source 41 to the inner bath 12 to clean the inside of the bath. After this cleaning, the wafer W is cast into pure water and at the time point t₁, the supply of a chemical liquid APM from the chemical liquid supply sources 43, 45 is started by the mixing device 40. Controlling the supply amount of the chemical liquid APM, pure water in the bath 12 is driven out of the bath to replace pure water with the chemical liquid APM. The concentration of the chemical liquid is adjusted to and kept at a certain concentration and the treatment of the wafer W is performed. By this treatment, organic dirt, attached particles and the like of the wafer W will be removed.

After the supply of the chemical liquid APM has been continued until the time point t₂, the supply of this chemical liquid is stopped and instead, the supply of pure water DIW from the pure water supply sources 41, 41a is started again to replace the chemical liquid APM with pure water DIW in the inner bath 12. After the cleaning with pure water has been performed from the time point t₃ to the time point t₄, the supply of pure water is stopped at the time point t₄ and instead, the supply of the chemical liquid DHF from the chemical liquid supply source 44 is started to replace pure water in the bath with the chemical liquid DHF. The treatment of the wafer with this chemical liquid is continued until the time point t₆. By this treatment, oxide films are removed. However, at the time point t₅ before the time point t₆, the supply of the chemical liquid DHF is stopped and at the same time, the replacement of the chemical liquid DHF with pure water in the bath is started again by starting the supply of pure water DIW. After the replacement has been completed, the cleaning with pure water is performed.

Afterward, in the same manner, the treatments with a chemical liquid HPM, pure water DIW and a chemical liquid O3 are performed. By these treatments, metal impurities are removed from the wafer W. Thereafter, after the last cleaning with pure water DIW has been completed, the drying is performed.

Also, in the treatment with the chemical liquid APM and the last cleaning treatment respectively in the dirt removal treatment process, during the time durations T₁ and T₂, the ultrasonic oscillating device 30 is operated to provide an ultrasonic treatment with both the chemical liquid and with the cleaning liquid.

### (2) Etching Treatment Process

FIG. 10B and FIG. 11A show etching treatment processes and the treatment process shown in FIG. 10B includes treatments with a chemical liquid H₂O₂, pure water DIW, a chemical liquid DHF and a chemical liquid HPM. In this treatment process, the chemical liquid DHF and the chemical liquid HPM are mixed at a specified concentration X ppm. This process becomes possible, because the treatment is performed in the same treatment bath.

In the treatment process shown in FIG. 1A, the treatment is performed, first using O₃ water in which O₃ is dissolved in pure water and next by the chemical liquid DHF. These treatment processes are performed in the treatment device shown in FIG. 5. Since the treatment procedure of this treatment process is the same as that of the treatment process of the above (1), the description thereof is omitted.

### (3) Last Cleaning Process

FIG. 11B shows the last cleaning process of the wafer and the treatments are performed with the chemical liquid APM, pure water DIW, the chemical liquid DHF and the chemical liquid HCl. This treatment process is performed in the treatment device shown in FIG. 5. Since the treatment procedure of this treatment process is the same as that of the treatment process of the above (1), the description thereof is omitted. In this process, O₃ water is not stopped completely and is flowed continuously in a small amount. This process becomes possible, because the treatment is performed in the same treatment bath.

1. A substrate treatment apparatus comprising:
a box-shaped treatment bath having an opening part at an upper side of said bath; and
a cover body openably covering said opening part of said treatment bath,
said cover body comprising a drying chamber formed therein for storing and drying a treated substrate, and
said treatment bath being so formed that at least three of treatment liquid supply nozzle tubes are disposed at each of opposed side wall faces of said bath forming said box shape horizontally at specified intervals and said supply nozzle tubes are formed to be connected to a switching mechanism to supply a treatment liquid from said opposed side wall sides while alternately switching said nozzle tubes at said opposed side wall faces,
at least one tube among said three supply nozzle tubes disposed at each of said opposed side wall faces being exclusively used for pure water.

2. (canceled)

3. The substrate treatment apparatus according to claim 1, wherein said at least three supply nozzle tubes respectively comprise a hollow cylinder in which a plurality of injection openings are formed at specified pitches in at least one row in the longitudinal direction of said hollow cylinder, and each of said at least three supply nozzle tubes is attached to said opposed side wall faces while directing each of said injection openings to a treated substrate which is arranged in the vertical direction.

4. The substrate treatment apparatus according to claim 1, wherein in said treatment bath, a bottom wall is inclined from the horizontal direction by a specified angle and a discharge outlet is formed at a lower end of said inclined bottom wall.

5. The substrate treatment apparatus according to any one of claims 1, 3 or 4, wherein in said treatment bath, an ultrasonic generating device is attached to an outer surface of said bottom wall.

6. The substrate treatment apparatus according to claim 1, wherein a plurality of injection nozzles are disposed in said drying chamber and said injection nozzles are connected to a dry vapor supply device for supplying a dry vapor containing submicron organic solvent mist.
